(19) United States
(12) Patent Application Publication
(10) Pub. No.: US 2004/0029476 A1
(43) Pub. Date: Feb. 12, 2004

(54) Thermoplastic spatial fabric application

(76) Inventor: James Hung, Yun-Lin (TW)

Correspondence Address: Hart, Baxley, Daniels & Holton, Fifth Floor, 59 John Street, New York, NY, 10038, US

(21) Appl. No.: 10/216,691

(22) Filed: Aug. 12, 2002

(51) Int. Cl. B32B 5/26

(52) U.S. Cl. 442/199; 442/209; 442/243; 442/246

(57) ABSTRACT

A thermoplastic spatial fabric application includes multiple spatial fabrics which are integrally combined with each other. Each spatial fabric includes at least two chemical fibers having different melting points, with the chemical fibers having a lower melting point being woven on a combination portion of each spatial fabric. The combination portions of the multiple spatial fabrics overlap each other and may be treated by a heating process, so that the overlapping combination portions of the multiple spatial fabrics may be melted and integrally combined with each other.

### BACKGROUND OF THE INVENTION

1. Field of the Invention

The present invention relates to a thermoplastic spatial fabric application, and more particularly to a thermoplastic spatial fabric application comprising multiple spatial fabrics each including at least two chemical fibers having different melting points, with the chemical fibers having a lower melting point being woven on a combination portion of each spatial fabric. The combination portions of the multiple spatial fabrics overlap each other and may be treated by a heating process, so that the overlapping combination portions of the multiple spatial fabrics may be melted and integrally combined with each other.

2. Description of the Related Art

A conventional cloth structure is usually made of cotton material, wool material, natural fiber or the like which is processed by a weaving technology to form the cloth structure. The conventional cloth structure made of the above-mentioned material has soft and deformable features. In the recent years, the cloth structure has various developments, and is available for different requirements of the industry. Especially, the chemical fiber cloth, such as the nylon cloth, non-woven cloth and the like, is dyed and processed easily, has a lower cost, is washed easily, and is used during a long-term, so that it is widely adopted and used in the industry. For example, the chemical fiber cloth is largely available for the clothes, shoes, hat, blanket, chair, partition plate and the like.

The chemical fiber cloth has to satisfy the requirements of thickness, elasticity, structural feature and the like. For example, the chemical fiber cloth needs to have an enough thickness, an enough stiffness, a proper elasticity and the like. The conventional method for making the chemical fiber cloth includes adopting multiple layers of cloth which are overlapped with each other, and providing glue and solvent (such as methyl benzene) which are coated between the multiple layers of cloth, so that the multiple layers of cloth may be bonded, thereby forming the cloth structure with the above-mentioned practical features.

It is appreciated that, the above-said conventional method for making the chemical fiber cloth has the following disadvantages.

1. In the cloth product made by bonding the multiple layers of cloth, the glue easily blocks each layer of cloth, thereby greatly reducing the permeability of the cloth structure.

2. When the multiple layers of cloth are bonded by the glue and the solvent, the solvent usually contains toxic material, thereby easily causing danger to the worker. In addition, after the cloth product is produced, the toxic material will be released gradually, thereby causing an environmental pollution.

3. In the cloth product made by bonding the multiple layers of cloth, the glue is easily broken by the ambient environment, such as the high temperature, the moisture and the like, during a period of time, so that the combination of the multiple layers of cloth becomes worse, thereby decreasing the structural strength of the cloth structure.

### SUMMARY OF THE INVENTION

The present invention has arisen to provide a spatial fabric which needs not to adopt the glue and solvent as is used in the conventional method for making the chemical fiber cloth, so as to overcome the disadvantages of the conventional method for making the chemical fiber cloth. Multiple spatial fabrics may be connected, thereby forming a spatial fabric having predetermined physical features, such as the stiffness, elasticity, softness, permeability or the like, so as to satisfy the practical requirements.

The primary objective of the present invention is to provide a thermoplastic spatial fabric application comprising multiple spatial fabrics each including at least two chemical fibers having different melting points, with the chemical fibers having a lower melting point being woven on a combination portion of each spatial fabric. The combination portions of the multiple spatial fabrics overlap each other and may be treated by a heating process, so that the overlapping combination portions of the multiple spatial fabrics may be melted and integrally combined with each other.

In accordance with the present invention, there is provided a thermoplastic spatial fabric application, comprising multiple spatial fabrics which are integrally combined with each other, each spatial fabric comprising at least two chemical fibers having different melting points, the chemical fibers having a lower melting point being woven on a combination portion of each spatial fabric, the combination portions of the multiple spatial fabrics overlapping each other; wherein,

the spatial fabrics may be treated by a heating process, with a heating temperature being higher than that of the chemical fiber having a lower melting point and lower than that of the chemical fiber having a higher melting point, so that the chemical fiber having a lower melting point is melted, and the chemical fiber having a higher melting point is not melted, and the overlapping combination portions of the multiple spatial fabrics may be melted and integrally combined with each other.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a thermoplastic spatial fabric application in accordance with a first embodiment of the present invention;

FIG. 2 is a side plan schematic view of the thermoplastic spatial fabric application as shown in FIG. 1;

FIG. 3 is an assembly view of the thermoplastic spatial fabric application as shown in FIG. 2;

FIG. 4 is an exploded perspective view of a thermoplastic spatial fabric application in accordance with a second embodiment of the present invention;

FIG. 5 is a side plan schematic view of the thermoplastic spatial fabric application as shown in FIG. 4; and

FIG. 6 is an assembly view of the thermoplastic spatial fabric application as shown in FIG. 5.

### DETAILED DESCRIPTION OF THE INVENTION

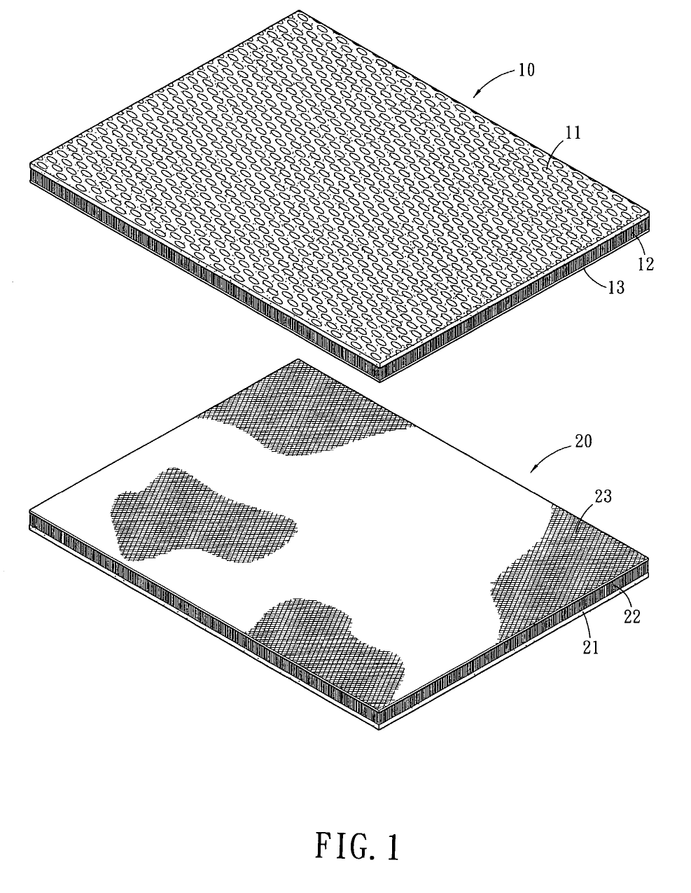

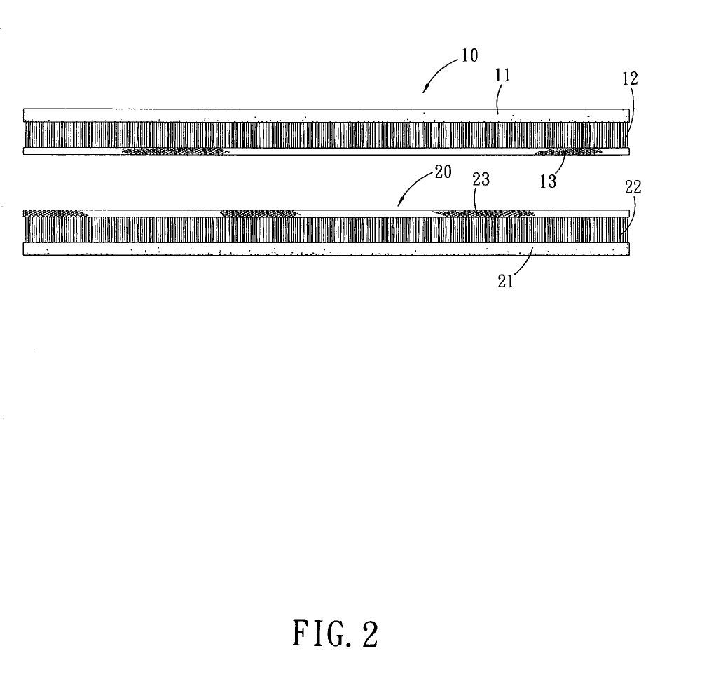

Referring to the drawings and initially to FIGS. 1 and 2, a thermoplastic spatial fabric application in accordance with a preferred embodiment of the present invention comprises at least two chemical fibers having different melting points. The chemical fibers are processed by a weaving technology, thereby forming a spatial fabric. Multiple spatial fabrics may be treated by a heating process, so that the multiple spatial fabrics may be integrally combined with each other, thereby forming a spatial fabric product with predetermined physical features.

The spatial fabric may be processed by a weaving technology, so that different fibers, such as PP, PET, NYLON or the like, may interweave with each other, thereby forming the structure of the spatial fabric having multiple layers. In addition, the layers of the spatial fabric are integrally combined with each other by a weaving technology (such as interweaving, hooking or the like) as shown in FIG. 1.

The above-mentioned chemical fiber may be formed according to the practical requirement, or may be woven into a predetermined structural state, for example, a soft fabric state, an upright fiber state, a soft and elastic non-woven fabric state, and the like. It is appreciated that, the chemical fibers or the formed fabric have different melting points, wherein the melting point is the melting temperature when the fiber is melted.

The melting points of the popular chemical fibers are listed as follows.

The melting point of PET is about 260° C.

The melting point of Ny66 is about 260° C.

The melting point of Ny6 is about 220° C.

The melting point of PP is about 170° C.

The spatial fabric in accordance with the present invention comprises at least two chemical fibers (such as PP, PET, Nylon or the like), whereby different chemical fibers are processed by a weaving technology, so that the chemical fibers may be intersected and formed, thereby forming a spatial fabric having multiple layers. In the present invention, each spatial fabric has a predetermined end face made of a chemical fiber having a lower melting point, thereby forming a combination portion.

Accordingly, the combination portions of multiple spatial fabrics may overlap each other, and the spatial fabrics may be treated by a heating process, wherein the heating temperature is higher than that of the chemical fiber having a lower melting point, and is lower than that of the chemical fiber having a higher melting point, so that the chemical fiber having a lower melting point is melted, and the chemical fiber having a higher melting point is not melted, thereby changing the original physical features of the spatial fabric, such as the stiffness, elasticity, softness, permeability or the like. Thus, the multiple spatial fabrics may be integrally combined with each other.

In the following descriptions, two preferred embodiments are illustrated, wherein each spatial fabric consists of three layers.

Referring to FIGS. 1 and 2, the spatial fabric application in accordance with a first embodiment of the present invention comprises a three-layer first spatial fabric 10, and a three-layer second spatial fabric 20.

The first spatial fabric 10 includes a first layer 11, a second layer 12 and a combination portion 13. The first layer 11 of the first spatial fabric 10 is made of a PET fiber with a melting point equal to 260° C. The first layer 11 of the first spatial fabric 10 may be formed into a cloth layer structural state. The second layer 12 of the first spatial fabric 10 is intersected with and juxtaposed to the first layer 11, and is made of a PET fiber with a melting point equal to 260° C. The second layer 12 of the first spatial fabric 10 may have an upright fiber state. The combination portion 13 of the first spatial fabric 10 is intersected with and juxtaposed to the second layer 12, and is made of a yarn containing the PP fiber with a melting point equal to 170° C. The combination portion 13 of the first spatial fabric 10 may be formed into a cloth layer structural state. In addition, the combination portion 13 of the first spatial fabric 10 may intersect with the end face of the second layer 12 in a whole manner as shown in FIG. 1.

The second spatial fabric 20 includes a first layer 21, a second layer 22 and a combination portion 23. The first layer 21 of the second spatial fabric 20 is made of a PET fiber with a melting point equal to 260° C. The first layer 21 of the second spatial fabric 20 may be formed into a cloth layer structural state. The second layer 22 of the second spatial fabric 20 is intersected with and juxtaposed to the first layer 21, and is made of a PET fiber with a melting point equal to 260° C. The second layer 22 of the second spatial fabric 20 may have an upright fiber state. The combination portion 23 of the second spatial fabric 20 is intersected with and juxtaposed to the second layer 22, and is made of a yarn containing the PP fiber with a melting point equal to 170° C. The combination portion 23 of the second spatial fabric 20 may be formed into a cloth layer structural state. In addition, the combination portion 23 of the second spatial fabric 20 may intersect with the end face of the second layer 22 in a whole manner as shown in FIG. 1.

In such a manner, the first spatial fabric 10 and the second spatial fabric 20 may be heated to increase the temperature, and may be pressurized so that the PP fibers of the combination portion 13 of the first spatial fabric 10 and the combination portion 23 of the second spatial fabric 20 may be pressed properly.

When the heating temperature is greater than or equal to 170° C. and is smaller than 260° C., the PP fibers of the combination portion 13 of the first spatial fabric 10 and the combination portion 23 of the second spatial fabric 20 are melted gradually, and are combined with each other.

At this time, the heating temperature does not reach the melting point of the PET fibers of the first layer 11 and the second layer 12 of the first spatial fabric 10 and the first layer 21 and the second layer 22 of the second spatial fabric 20, so that the PET fibers of the first layer 11 and the second layer 12 of the first spatial fabric 10 and the first layer 21 and the second layer 22 of the second spatial fabric 20 are not melted and will keep the original state.

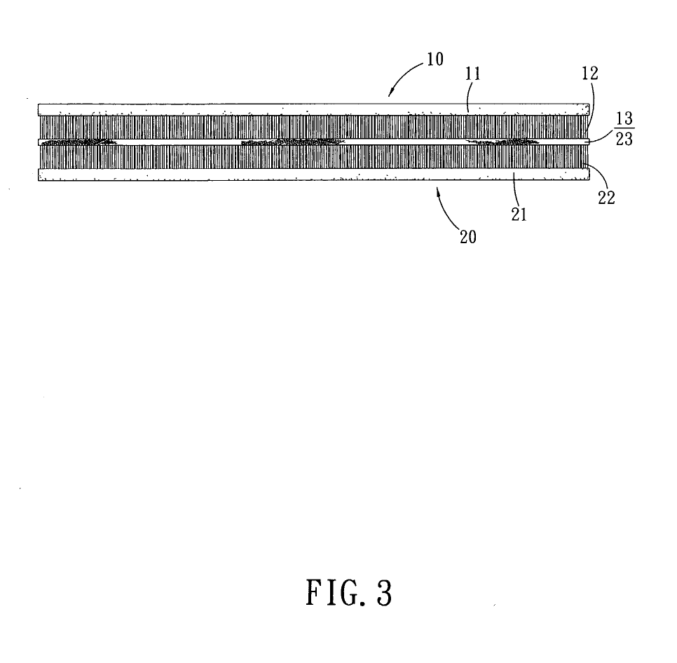

Then, the heating temperature is decreased gradually, so that the PP fibers of the combination portion 13 of the first spatial fabric 10 and the combination portion 23 of the second spatial fabric 20 are solidified and formed. After the PP fibers of the combination portion 13 of the first spatial fabric 10 and the combination portion 23 of the second spatial fabric 20 are solidified, the PP fibers of the combination portion 13 of the first spatial fabric 10 and the combination portion 23 of the second spatial fabric 20 are integrally and closely combined with each other, thereby forming the spatial fabric product as shown in FIG. 3.

It is appreciated that, the combination portion 13 of the first spatial fabric 10 and the combination portion 23 of the second spatial fabric 20 may be combined in a whole manner, and may also be combined in a predetermined local manner, which will be described as follows.

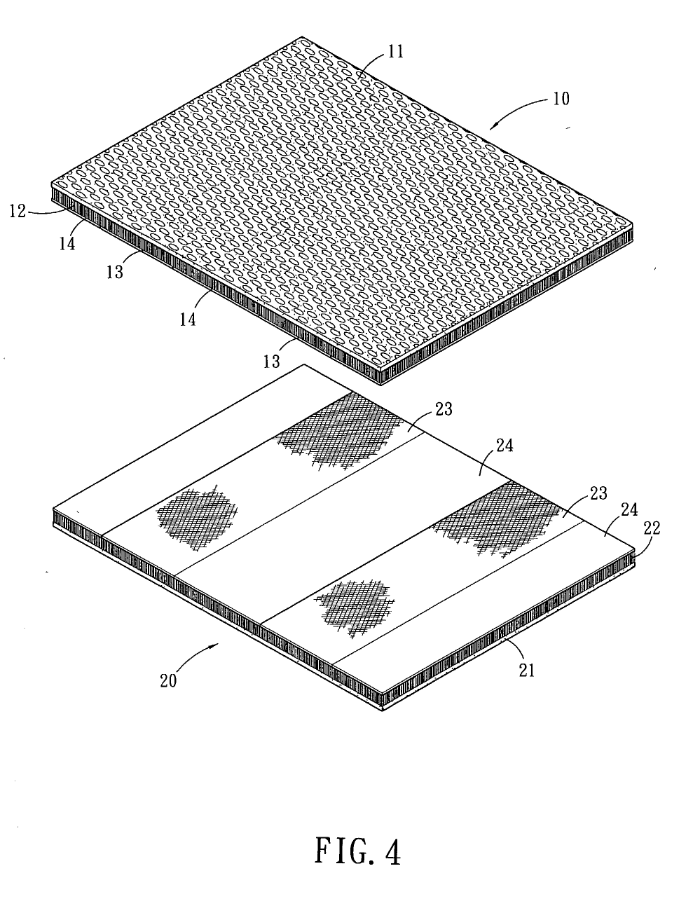

Referring to FIGS. 4-6, the spatial fabric application in accordance with a second embodiment of the present invention comprises a three-layer first spatial fabric 10, and a three-layer second spatial fabric 20.

The first spatial fabric 10 includes a first layer 11, a second layer 12 and a third layer 14. The first layer 11 of the first spatial fabric 10 is made of a PET fiber with a melting point equal to 260° C. The first layer 11 of the first spatial fabric 10 may be formed into a cloth layer structural state. The second layer 12 of the first spatial fabric 10 is intersected with and juxtaposed to the first layer 11, and is made of a PET fiber with a melting point equal to 260° C. The second layer 12 of the first spatial fabric 10 may have an upright fiber state. The third layer 14 of the first spatial fabric 10 is intersected with and juxtaposed to the second layer 12, and is made of a PET fiber with a melting point equal to 260° C. The third layer 14 of the first spatial fabric 10 may be formed into a cloth layer structural state.

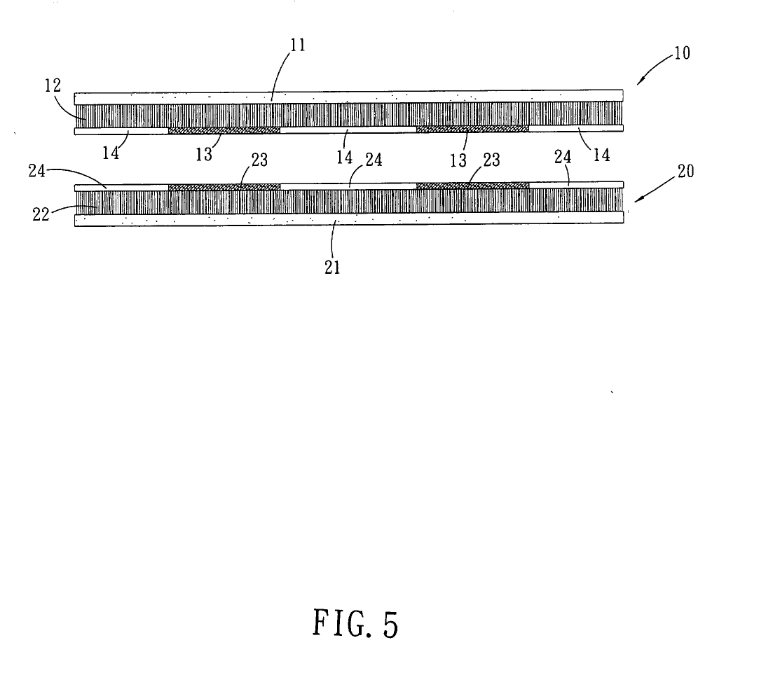

It is appreciated that, the third layer 14 of the first spatial fabric 10 has predetermined positions formed with a combination portion 13 in a mixing weaving manner. The combination portion 13 of the first spatial fabric 10 is made of a yarn containing the PP fiber with a melting point equal to 170° C. That is, the third layer 14 of the first spatial fabric 10 is primarily made of a PET fiber, and is locally formed with the PP fiber with a lower melting point, thereby forming the combination portion 13 as shown in FIG. 5.

The second spatial fabric 20 includes a first layer 21, a second layer 22 and a third layer 24. The first layer 21 of the second spatial fabric 20 is made of a PET fiber with a melting point equal to 260° C. The first layer 21 of the second spatial fabric 20 may be formed into a cloth layer structural state. The second layer 22 of the second spatial fabric 20 is intersected with and juxtaposed to the first layer 21, and is made of a PET fiber with a melting point equal to 260° C. The second layer 22 of the second spatial fabric 20 may have an upright fiber state. The third layer 24 of the second spatial fabric 20 is intersected with and juxtaposed to the second layer 22, and is made of a PET fiber with a melting point equal to 260° C. The third layer 24 of the second spatial fabric 20 may be formed into a cloth layer structural state.

It is appreciated that, the third layer 24 of the second spatial fabric 20 has predetermined positions formed with a combination portion 23 in a mixing weaving manner. The combination portion 23 of the second spatial fabric 20 is made of a yarn containing the PP fiber with a melting point equal to 170° C. That is, the third layer 24 of the second spatial fabric 20 is primarily made of a PET fiber, and is locally formed with the PP fiber with a lower melting point, thereby forming the combination portion 23 as shown in FIG. 5.

In such a manner, the first spatial fabric 10 and the second spatial fabric 20 may be heated to increase the temperature, and may be pressurized so that the PP fibers of the combination portion 13 of the first spatial fabric 10 and the combination portion 23 of the second spatial fabric 20 may be pressed properly. When the heating temperature is greater than or equal to 170° C. and is smaller than 260° C., the PP fibers of the combination portion 13 of the first spatial fabric 10 and the combination portion 23 of the second spatial fabric 20 are melted gradually, and are combined with each other.

At this time, the heating temperature does not reach the melting point of the PET fibers of the first layer 11, the second layer 12 and the third layer 14 of the first spatial fabric 10 and the first layer 21, the second layer 22 and the third layer 24 of the second spatial fabric 20, so that the PET fibers of the first layer 11, the second layer 12 and the third layer 14 of the first spatial fabric 10 and the first layer 21, the second layer 22 and the third layer 24 of the second spatial fabric 20 are not melted and will keep the original state.

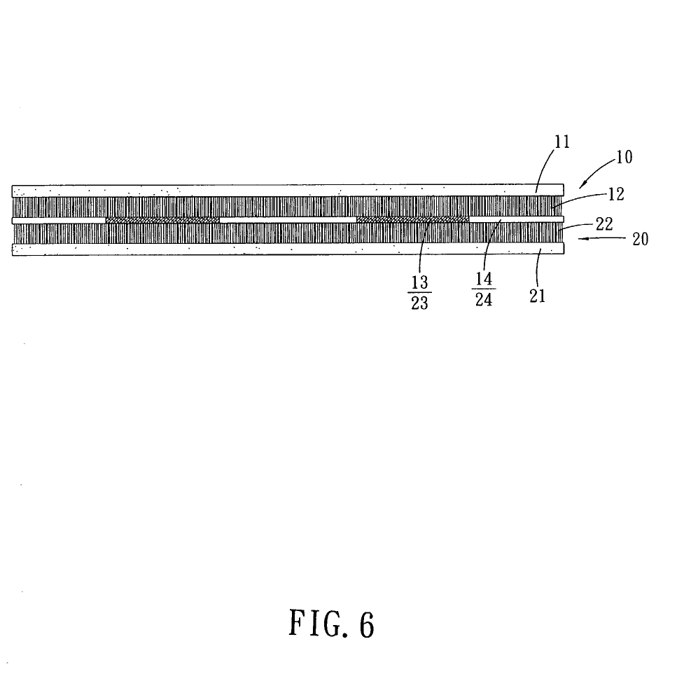

Then, the heating temperature is decreased gradually, so that the PP fibers of the combination portion 13 of the first spatial fabric 10 and the combination portion 23 of the second spatial fabric 20 are solidified and formed. After the PP fibers of the combination portion 13 of the first spatial fabric 10 and the combination portion 23 of the second spatial fabric 20 are solidified, the PP fibers of the combination portion 13 of the first spatial fabric 10 and the combination portion 23 of the second spatial fabric 20 are integrally and closely combined with each other, thereby forming the spatial fabric product as shown in FIG. 6.

Thus, the first spatial fabric 10 and the second spatial fabric 20 are integrally and closely combined with each other, thereby forming the spatial fabric product as shown in FIG. 6. That is, the combination portion 13 of the first spatial fabric 10 and the combination portion 23 of the second spatial fabric 20 may be formed in a local or whole manner. It is appreciated that, when the combination portion 13 of the first spatial fabric 10 and the combination portion 23 of the second spatial fabric 20 are formed in a local (mixing weaving) manner, the melting positions are locally located at the spatial fabric, so that the spatial fabric product may have a greater permeability.

Accordingly, the spatial fabric product in accordance with the present invention is made by using the difference of the melting points of the chemical fibers, and is treated by a heating process, so that multiple spatial fabrics may be integrally combined with each other by melting of the combinations, and other layers that do not reach the melting point may maintain the original physical features. Thus, the spatial fabric product in accordance with the present invention may satisfy the practical requirements of the industry. For example, the spatial fabric product in accordance with the present invention is largely available for the clothes, shoes, hat, blanket, chair, partition plate and the like. Thus, the spatial fabric product in accordance with the present invention needs not to adopt the glue and solvent as is used in the conventional method for making the chemical fiber cloth, and may overcome the disadvantages of the conventional method for making the chemical fiber cloth.

In conclusion, the thermoplastic spatial fabric application in accordance with the present invention comprises at least two chemical fibers having different melting points, thereby forming a spatial fabric. The chemical fibers having a lower melting point are woven on the combination portion of each spatial fabric. Accordingly, the combination portions of multiple spatial fabrics may overlap each other, and the spatial fabrics may be treated by a heating process, wherein the heating temperature is higher than that of the chemical fiber having a lower melting point, and is lower than that of the chemical fiber having a higher melting point, so that the chemical fiber having a lower melting point is melted, and the chemical fiber having a higher melting point is not melted. Thus, the overlapping combination portions of the multiple spatial fabrics may be melted and integrally combined with each other, thereby forming a spatial fabric product with a predetermined state, so as to satisfy the practical requirements.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A thermoplastic spatial fabric application, comprising multiple spatial fabrics which are integrally combined with each other, each spatial fabric comprising at least two chemical fibers having different melting points, the chemical fibers having a lower melting point being woven on a combination portion of each spatial fabric, the combination portions of the multiple spatial fabrics overlapping each other; wherein,
the spatial fabrics may be treated by a heating process, with a heating temperature being higher than that of the chemical fiber having a lower melting point and lower than that of the chemical fiber having a higher melting point, so that the chemical fiber having a lower melting point is melted, and the chemical fiber having a higher melting point is not melted, and the overlapping combination portions of the multiple spatial fabrics may be melted and integrally combined with each other.

2. The thermoplastic spatial fabric application in accordance with claim 1, wherein the spatial fabric application comprises a three-layer first spatial fabric, and a three-layer second spatial fabric;
the first spatial fabric includes a first layer, a second layer and a combination portion, the first layer of the first spatial fabric is made of a PET fiber with a melting point equal to 260°, the second layer of the first spatial fabric is intersected with and juxtaposed to the first layer, and is made of a PET fiber with a melting point equal to 260° C., the combination portion of the first spatial fabric is intersected with and juxtaposed to the second layer, and is made of a yarn containing the PP fiber with a melting point equal to 170° C.;
the second spatial fabric includes a first layer, a second layer and a combination portion, the first layer of the second spatial fabric is made of a PET fiber with a melting point equal to 260° C., the second layer of the second spatial fabric is intersected with and juxtaposed to the first layer, and is made of a PET fiber with a melting point equal to 260° C., the combination portion of the second spatial fabric is intersected with and juxtaposed to the second layer, and is made of a yarn containing the PP fiber with a melting point equal to 170° C.;
the first spatial fabric and the second spatial fabric may be heated to increase a heating temperature;
when the heating temperature is greater than or equal to 170° C. and is smaller than 260° C., the PP fibers of the combination portion of the first spatial fabric and the combination portion of the second spatial fabric are melted gradually, and are combined with each other;
when the heating temperature is decreased gradually, the PP fibers of the combination portion of the first spatial fabric and the combination portion of the second spatial fabric are solidified and formed; and
after the PP fibers of the combination portion of the first spatial fabric and the combination portion of the second spatial fabric are solidified, the PP fibers of the combination portion of the first spatial fabric and the combination portion of the second spatial fabric are integrally and closely combined with each other, thereby forming the spatial fabric product.

3. The thermoplastic spatial fabric application in accordance with claim 1, wherein the spatial fabric application comprises a three-layer first spatial fabric, and a three-layer second spatial fabric;
the first spatial fabric includes a first layer, a second layer and a third layer, the first layer of the first spatial fabric is made of a PET fiber with a melting point equal to 260° C., the second layer of the first spatial fabric is intersected with and juxtaposed to the first layer, and is made of a PET fiber with a melting point equal to 260° C., the third layer of the first spatial fabric is intersected with and juxtaposed to the second layer, and is made of a PET fiber with a melting point equal to 260° C., the third layer of the first spatial fabric has predetermined positions formed with a combination portion made of a yarn containing the PP fiber with a melting point equal to 170° C.;
the second spatial fabric includes a first layer, a second layer and a third layer, the first layer of the second spatial fabric is made of a PET fiber with a melting point equal to 260° C., the second layer of the second spatial fabric is intersected with and juxtaposed to the first layer, and is made of a PET fiber with a melting point equal to 260° C., the third layer of the second spatial fabric is intersected with and juxtaposed to the second layer, and is made of a PET fiber with a melting point equal to 260° C., the third layer of the second spatial fabric has predetermined positions formed with a combination portion made of a yarn containing the PP fiber with a melting point equal to 170° C.;
the first spatial fabric and the second spatial fabric may be heated to increase a heating temperature;
when the heating temperature is greater than or equal to 170° C. and is smaller than 260° C., the PP fibers of the combination portion of the first spatial fabric and the combination portion of the second spatial fabric are melted gradually, and are combined with each other;
when the heating temperature is decreased gradually, the PP fibers of the combination portion of the first spatial fabric and the combination portion of the second spatial fabric are solidified and formed; and
after the PP fibers of the combination portion of the first spatial fabric and the combination portion of the second spatial fabric are solidified, the PP fibers of the combination portion of the first spatial fabric and the combination portion of the second spatial fabric are integrally and closely combined with each other, thereby forming the spatial fabric product.

4. The thermoplastic spatial fabric application in accordance with claim 2, wherein the combination portion may intersect with an end face of the spatial fabric in a whole manner.

5. The thermoplastic spatial fabric application in accordance with claim 3, wherein the combination portion may intersect with the spatial fabric in a local manner.
